(19) United States
(12) Patent Application Publication
(10) Pub. No.: US 2017/0076430 A1
(43) Pub. Date: Mar. 16, 2017

(54) Image Processing Method and Image Processing Apparatus

(71) Applicant: Huawei Technologies Co., Ltd., Shenzhen (CN)

(72) Inventor: Jing Xu, Shenzhen (CN)

(21) Appl. No.: 15/361,640

(22) Filed: Nov. 28, 2016

Related U.S. Application Data
(63) Continuation of application No. PCT/CN2015/080021, filed on May 28, 2015.

(30) Foreign Application Priority Data
May 28, 2014 (CN) 201410230506.1

(51) Int. Cl. G06T 5/00; G06F 3/0488; H04N 5/232; G06F 3/0484; G06T 7/00; G06T 11/60

(52) U.S. Cl. CPC G06T 5/001; G06T 7/0069; G06T 11/60; H04N 5/23293; G06F 3/04842; G06F 3/04883; G06F 3/04845; G06T 2207/20221

(57) ABSTRACT

An image processing method and an image processing apparatus is disclosed. The method includes determining depth information of multiple depth planes, where the depth information of the multiple depth planes is used to indicate the multiple depth planes, the multiple depth planes are respectively corresponding to multiple refocused images of the multiple depth planes, and the multiple refocused images are generated based on raw data of the multiple refocused images, and generating a refocused image of the multiple depth planes according to the depth information, where the refocused image of the multiple depth planes includes focused parts of the multiple refocused images. In the technical solutions of the present application, clear images of objects in multiple depth planes can be simultaneously obtained.

### CROSS-REFERENCE TO RELATED APPLICATIONS

This application is a continuation of International Application No. PCT/CN2015/080021, filed on May 28, 2015, which claims priority to Chinese Patent Application No. 201410230506.1, filed on May 28, 2014, both of which are hereby incorporated by reference in their entireties.

### TECHNICAL FIELD

The present application relates to the field of image processing technologies, and in particular, to an image processing method and an image processing apparatus.

### BACKGROUND

In common photography, to highlight a subject scene, a camera is usually focused on a depth plane in which the subject scene is located such that the subject scene is clearly imaged on a sensor, but imaging of an object in another depth plane is blurry.

With development of a digital imaging technology, image processing, and machine vision, a refocusing technology emerges. According to the refocusing technology, after an image is formed, according to a user need, a focusing plane or a depth of field may be reselected, where the depth of field refers to a scope in which an imaging device can provide clear imaging.

For example, the refocusing technology is used in a light field camera. A micro lens array is included in the light field camera. When shooting is performed, each micro lens in the micro lens array forms an image on a sensor, and therefore an image array is obtained. In addition, the image array may be processed using a refocusing algorithm to obtain a refocused image of a depth plane. After the refocused image is formed, a user can obtain a focused image of a scene in one depth plane according to a need each time. In this way, the user can view a clear image of a scene only in one depth plane, while an image, which is viewed by the user, of a scene in another depth plane is blurry.

### SUMMARY

Embodiments of the present application provide an image processing method and an image processing apparatus such that clear images of scenes in multiple depth planes can be simultaneously obtained.

According to a first aspect, an image processing method is provided, including determining depth information of multiple depth planes, where the depth information of the multiple depth planes is used to indicate the multiple depth planes, the multiple depth planes are respectively corresponding to multiple refocused images of the multiple depth planes, and the multiple refocused images are generated based on raw data of the multiple refocused images, and generating a refocused image of the multiple depth planes according to the depth information, where the refocused image of the multiple depth planes includes focused parts of the multiple refocused images.

With reference to the first aspect, in a first possible implementation manner, the multiple depth planes are respectively corresponding to the raw data of the multiple refocused images, and the generating a refocused image of the multiple depth planes according to the depth information includes determining the raw data of the multiple refocused images according to the depth information of the multiple depth planes, and generating the refocused image of the multiple depth planes according to the raw data of the multiple refocused images, where the refocused image of the multiple depth planes includes the focused parts of the multiple refocused images.

With reference to the first possible implementation manner, in a second possible implementation manner, the generating the refocused image of the multiple depth planes according to the raw data of the multiple refocused images includes performing refocusing processing based on the raw data of the multiple refocused images using a refocusing algorithm to generate the multiple refocused images, and combining the multiple refocused images to generate the refocused image of the multiple depth planes.

With reference to the second possible implementation manner, in a third possible implementation manner, the combining the multiple refocused images includes combining the focused parts of the multiple refocused images using an image fusion method.

With reference to the third possible implementation manner, in a fourth possible implementation manner, the combining the focused parts of the multiple refocused images using an image fusion method includes determining a point spread function of pixels of the multiple refocused images, generating a fusion weight template according to the point spread function of the pixels, where the fusion weight template includes fusion weights of the pixels, and a fusion weight of a pixel of a high focusing degree is greater than a fusion weight of a pixel of a low focusing degree, and performing image fusion on the multiple refocused images according to the fusion weight template.

With reference to the second possible implementation manner, in a fifth possible implementation manner, each refocused image in the multiple refocused images includes focused parts and non-focused parts, and the combining the multiple refocused images includes selecting the focused parts and the non-focused parts from each refocused image in the multiple refocused images, and splicing the focused parts and the non-focused parts.

With reference to the first possible implementation manner, in a sixth possible implementation manner, the generating the refocused image of the multiple depth planes according to the raw data of the multiple refocused images includes determining the raw data of the multiple refocused images according to the depth information of the multiple depth planes, generating, according to the raw data of the multiple refocused images, focused parts and non-focused parts that are of each refocused image in the multiple refocused images, and splicing the focused parts and the non-focused parts.

With reference to the first aspect, in a seventh possible implementation manner, the method of the first aspect further includes generating, according to raw data of refocused images of all depth planes, the refocused images corresponding to all the depth planes, where all the depth planes are respectively corresponding to the refocused images of all the depth planes, and the generating a refocused image of the multiple depth planes according to the depth information includes selecting the refocused images of the multiple depth planes from the refocused images of all the depth planes according to the depth information of the multiple depth planes, and generating the refocused image of the multiple depth planes according to the refocused images of the multiple depth planes, where the refocused image of the multiple depth planes includes the focused parts of the multiple refocused images.

With reference to the seventh possible implementation manner, in an eighth possible implementation manner, the generating the refocused image of the multiple depth planes according to the refocused images of the multiple depth planes includes determining a point spread function of pixels of all the refocused images, generating a fusion weight template according to the point spread function of the pixels of all the refocused images, where the fusion weight template includes fusion weights of the pixels of all the refocused images, fusion weights of pixels of the multiple refocused images are greater than fusion weights of pixels of other refocused images except the multiple refocused images in all the refocused images, and a fusion weight of a pixel of a high focusing degree in the multiple refocused images is greater than a fusion weight of a pixel of a low focusing degree in the multiple refocused images, and performing image fusion on all the refocused images according to the fusion weight template.

With reference to the seventh possible implementation manner, in a ninth possible implementation manner, the generating the refocused image of the multiple depth planes according to the multiple refocused images of the multiple depth planes includes selecting focused parts and non-focused parts from each refocused image in the multiple refocused images, and splicing the focused parts and the non-focused parts.

With reference to the seventh possible implementation manner, in a tenth possible implementation manner, the method of the first aspect further includes querying the focused parts and non-focused parts that are of the refocused images of the multiple depth planes from query tables using a depth of a depth plane or pixel coordinates as an index, where the focused parts and the non-focused parts are stored in the query tables using the depth of the depth plane or the pixel coordinates as the index, and the generating the refocused image of the multiple depth planes according to the refocused images of the multiple depth planes includes splicing the focused parts and the non-focused parts that are of the refocused images of the multiple depth planes.

With reference to the fifth, sixth, ninth, or tenth possible implementation manner, in an eleventh possible implementation manner, the splicing the focused parts and the non-focused parts includes performing pre-processing, image registration, and image fusion on images of the focused parts and images of the non-focused parts.

With reference to the first aspect or any one of the foregoing possible implementation manners, in a twelfth possible implementation manner, the method of the first aspect further includes displaying a refocused image in the multiple refocused images, acquiring multiple user inputs in multiple regions of the displayed refocused image, where the multiple user inputs are corresponding to the multiple depth planes, and outputting the generated refocused image of the multiple depth planes on a display device, and the determining depth information of multiple depth planes includes determining the depth information of the multiple depth planes according to the multiple user inputs.

With reference to the twelfth possible implementation manner, in a thirteenth possible implementation manner, the user inputs are one of the following single-point tap inputs, multi-point tap inputs, single-point sliding inputs, or multi-point sliding inputs on a touchscreen by a user, user postures probed by a posture sensor on an input device, or user actions probed by an action tracking module on an input device.

With reference to the first aspect or any one of the foregoing possible implementation manners, in a fourteenth possible implementation manner, the determining depth information of multiple depth planes includes determining, according to a predefined input, the multiple depth planes corresponding to the predefined input, and the method further includes outputting, on a display device, the refocused image of the multiple depth planes corresponding to the predefined input.

According to a second aspect, an image processing apparatus is provided, including a determining module configured to determine depth information of multiple depth planes, where the depth information of the multiple depth planes is used to indicate the multiple depth planes, the multiple depth planes are respectively corresponding to multiple refocused images of the multiple depth planes, and the multiple refocused images are generated based on raw data of the multiple refocused images, and a generation module configured to generate a refocused image of the multiple depth planes according to the depth information, where the refocused image of the multiple depth planes includes focused parts of the multiple refocused images.

With reference to the second aspect, in a first possible implementation manner, the multiple depth planes are respectively corresponding to the raw data of the multiple refocused images, and the generation module determines the raw data of the multiple refocused images according to the depth information of the multiple depth planes, and generates the refocused image of the multiple depth planes according to the raw data of the multiple refocused images, where the refocused image of the multiple depth planes includes the focused parts of the multiple refocused images.

With reference to the first possible implementation manner, in a second possible implementation manner, the generation module performs refocusing processing based on the raw data of the multiple refocused images using a refocusing algorithm to generate the multiple refocused images, and combines the multiple refocused images to generate the refocused image of the multiple depth planes.

With reference to the second possible implementation manner of the second aspect, in a third possible implementation manner, the generation module combines the focused parts of the multiple refocused images using an image fusion method.

With reference to the third possible implementation manner of the second aspect, in a fourth possible implementation manner, the generation module determines a point spread function of pixels of the multiple refocused images, generates a fusion weight template according to the point spread function of the pixels, and performs image fusion on the multiple refocused images according to the fusion weight template, where the fusion weight template includes fusion weights of the pixels, and a fusion weight of a pixel of a high focusing degree is greater than a fusion weight of a pixel of a low focusing degree.

With reference to the second possible implementation manner of the second aspect, in a fifth possible implementation manner, the generation module selects focused parts and non-focused parts from each refocused image in the multiple refocused images, and splices the focused parts and the non-focused parts.

With reference to the first possible implementation manner of the second aspect, in a sixth possible implementation manner, the generation module determines the raw data of the multiple refocused images according to the depth information of the multiple depth planes, generates, according to the raw data of the multiple refocused images, focused parts and non-focused parts that are of each refocused image in the multiple refocused images, and splices the focused parts and the non-focused parts.

With reference to the second aspect, in a seventh possible implementation manner, the generation module generates, according to raw data of refocused images of all depth planes, the refocused images corresponding to all the depth planes, where all the depth planes are respectively corresponding to the refocused images of all the depth planes, selects the refocused images of the multiple depth planes from the refocused images of all the depth planes according to the depth information of the multiple depth planes, and generates the refocused image of the multiple depth planes according to the refocused images of the multiple depth planes, where the refocused image of the multiple depth planes includes the focused parts of the multiple refocused images.

With reference to the seventh possible implementation manner of the second aspect, in an eighth possible implementation manner, the generation module determines a point spread function of pixels of all the refocused images, generates a fusion weight template according to the point spread function of the pixels of all the refocused images, and performs image fusion on all the refocused images according to the fusion weight template, where the fusion weight template includes fusion weights of the pixels of all the refocused images, fusion weights of pixels of the multiple refocused images are greater than fusion weights of pixels of other refocused images except the multiple refocused images in all the refocused images, and a fusion weight of a pixel of a high focusing degree in the multiple refocused images is greater than a fusion weight of a pixel of a low focusing degree in the multiple refocused images.

With reference to the seventh possible implementation manner of the second aspect, in a ninth possible implementation manner, the generation module selects focused parts and non-focused parts from each refocused image in the multiple refocused images, and splices the focused parts and the non-focused parts.

With reference to the seventh possible implementation manner of the second aspect, in a tenth possible implementation manner, the image processing apparatus of the second aspect further includes a query module configured to query the focused parts and non-focused parts that are of the refocused images of the multiple depth planes from query tables using a depth of a depth plane or pixel coordinates as an index, where the focused parts and the non-focused parts are stored in the query tables using the depth of the depth plane or the pixel coordinates as the index, and the generation module splices the focused parts and the non-focused parts that are of the refocused images of the multiple depth planes.

With reference to the fifth, sixth, ninth, or tenth possible implementation manner, in an eleventh possible implementation manner, the generation module performs pre-processing, image registration, and image fusion on images of the focused parts and images of the non-focused parts when performing the splicing.

With reference to the second aspect or any one of the foregoing possible implementation manners, in a twelfth possible implementation manner, the image processing apparatus of the second aspect further includes a display module configured to display a refocused image in the multiple refocused images, and an acquiring module configured to acquire multiple user inputs in multiple regions of the displayed refocused image, where the multiple user inputs are corresponding to the multiple depth planes, the display module outputs the generated refocused image of the multiple depth planes on a display device, and the determining module determines the depth information of the multiple depth planes according to the multiple user inputs.

With reference to the twelfth possible implementation manner, in a thirteenth possible implementation manner, the user inputs are one of the following single-point tap inputs, multi-point tap inputs, single-point sliding inputs, or multi-point sliding inputs on a touchscreen by a user, user postures probed by a posture sensor on an input device, or user actions probed by an action tracking module on an input device.

With reference to the second aspect or any one of the foregoing possible implementation manners, in a fourteenth possible implementation manner, the determining module determines, according to a predefined input, the multiple depth planes corresponding to the predefined input, and the image processing apparatus further includes a display module configured to output, on a display device, the refocused image of the multiple depth planes corresponding to the predefined input.

In the technical solutions of the present application, a refocused image of multiple depth planes may be generated according to depth information. Because the refocused image of the multiple depth planes includes focused parts of multiple refocused images, the focused parts of the multiple refocused images can be simultaneously displayed, and therefore clear images of scenes in the multiple depth planes can be simultaneously obtained.

### BRIEF DESCRIPTION OF DRAWINGS

To describe the technical solutions in the embodiments of the present application more clearly, the following briefly describes the accompanying drawings required for describing the embodiments of the present application. Apparently, the accompanying drawings in the following description show merely some embodiments of the present application, and a person of ordinary skill in the art may still derive other drawings from these accompanying drawings without creative efforts.

FIG. 1 is a schematic flowchart of an image processing method according to an embodiment of the present application.

FIG. 2 is a schematic flowchart of an image processing process according to another embodiment of the present application.

FIG. 3 shows a schematic diagram of a correspondence between a depth plane and a user input.

FIG. 4 is a schematic diagram of two planes in a double-plane representation method according to an embodiment of the present application.

FIG. 5 is a schematic diagram of a principle of synthetic image photography according to an embodiment of the present application.

FIG. 6 is a schematic diagram of a geometrical relationship of a model of a principle of synthetic image photography according to an embodiment of the present application.

FIG. 7 is a schematic flowchart of an image processing process according to still another embodiment of the present application.

FIG. 8 is a schematic flowchart of an image processing process according to another embodiment of the present application.

FIG. 9 is a schematic flowchart of an image processing process according to still another embodiment of the present application.

FIG. 10 is a schematic structural diagram of an image processing apparatus according to an embodiment of the present application.

FIG. 11 is a schematic structural diagram of an image processing apparatus according to another embodiment of the present application.

### DESCRIPTION OF EMBODIMENTS

The following clearly describes the technical solutions in the embodiments of the present application with reference to the accompanying drawings in the embodiments of the present application. Apparently, the described embodiments are some but not all of the embodiments of the present application. All other embodiments obtained by a person of ordinary skill in the art based on the embodiments of the present application without creative efforts shall fall within the protection scope of the present application.

In the embodiments of the present application, a depth may refer to a distance between a scene and a camera. Multiple depth planes may be continuous in depth, which are not limited in the embodiments of the present application, for example, the multiple depth planes may also be discontinuous in depth. It should be understood that each depth plane may be corresponding to one focusing plane, and may also be corresponding to one depth of field. It should be noted that the “multiple” in this specification includes two or more.

The embodiments of the present application may be applied to a camera, or may be applied to another user terminal (such as a mobile phone or a computer), and the camera or the another user terminal is configured to process raw data of a refocused image to generate a refocused image of multiple depth planes.

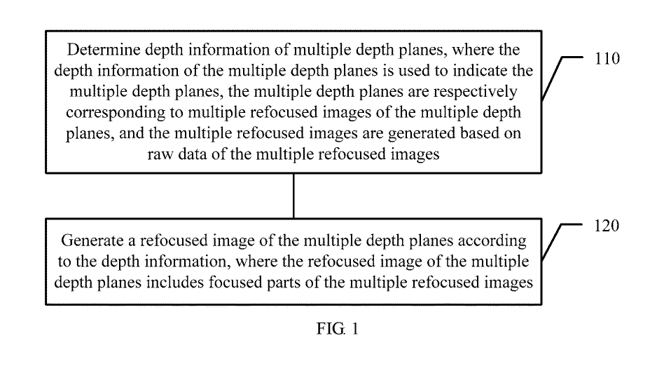

FIG. 1 is a schematic flowchart of an image processing method according to an embodiment of the present application. The method in FIG. 1 may be executed by an image processing apparatus. The method in FIG. 1 includes the following content.

110. Determine depth information of multiple depth planes, where the depth information of the multiple depth planes is used to indicate the multiple depth planes, the multiple depth planes are respectively corresponding to multiple refocused images of the multiple depth planes, and the multiple refocused images are generated based on raw data of the multiple refocused images.

The depth information may include at least one of information about depth planes, information about pixel coordinates, information about pixel colors, information about a point spread function of pixels, light field information of light rays corresponding to pixels, or trace information of light rays corresponding to pixels, or any combination of them. A manner for determining the depth information of the multiple depth planes is not limited in this embodiment of the present application. The depth information may come from user inputs or may be predefined.

The image processing apparatus may obtain, according to user inputs or predefined inputs, depth planes corresponding to regions that need to be refocused. For example, the depth planes corresponding to the regions that need to be refocused are determined according to real-time inputs or selections of a user on a user interface. When the user selects multiple regions on the user interface, where the multiple regions are corresponding to depth planes, the image processing apparatus may learn, according to this, the depth planes corresponding to the regions that need to be refocused. According to this embodiment of the present application, the manner for determining the depth information of the multiple depth planes is not limited thereto, and the image processing apparatus may also determine the depth information of the multiple depth planes according to predefined information.

120. Generate a refocused image of the multiple depth planes according to the depth information, where the refocused image of the multiple depth planes includes focused parts of the multiple refocused images.

For example, in a refocused image corresponding to each depth plane, a part of the image is focused, that is, the part of the image is clear, but another part of the image is not focused, that is, the another part of the image is blurry. Determining the depth information of the multiple depth planes is to determine depth planes in which images need to be refocused. In this case, a process of generating the refocused image of the multiple depth planes may be combining the focused parts corresponding to the multiple depth planes. In addition, in the generated refocused image of the multiple depth planes, the focused parts and non-focused parts that are corresponding to the multiple depth planes may be combined, and therefore a complete image can be presented.

According to this embodiment of the present application, a refocused image of multiple depth planes may be generated according to depth information. Because the refocused image of the multiple depth planes includes focused parts of multiple refocused images, the focused parts of the multiple refocused images can be simultaneously displayed, and therefore clear images of scenes in the multiple depth planes can be simultaneously obtained.

In 120, the image processing apparatus may determine the raw data of the multiple refocused images according to the depth information of the multiple depth planes, and generate the refocused image of the multiple depth planes according to the raw data of the multiple refocused images, where the refocused image of the multiple depth planes includes the focused parts of the multiple refocused images.

For example, the raw data of the refocused images corresponding to the depth planes may be determined according to the depth information input by the user, or the depth planes that need to be refocused and the raw data of the refocused images corresponding to the depth planes may be determined according to the predefined depth information. A method for obtaining the information about the refocused depth planes according to the user inputs or the predefined input may vary according to a type of the raw data.

The image processing apparatus may generate the focused parts according to the raw data of the refocused images, may generate non-focused parts according to the raw data of the refocused images, or may generate both the focused parts and the non-focused parts according to the raw data of the refocused images. For example, the raw data may be obtained by means of shooting by a camera module (for example, a light field camera) that is provided with a micro lens array. Each depth plane has raw data of a refocused image of the depth plane, and the raw data is used to generate, according to a need, the refocused image corresponding to the depth plane.

According to this embodiment of the present application, a refocused image of multiple depth planes may be generated according to raw data of multiple refocused images corresponding to the multiple depth planes. Because the refocused image of the multiple depth planes includes focused parts of the multiple refocused images, the focused parts of the multiple refocused images can be simultaneously displayed, and therefore clear images of scenes in the multiple depth planes can be simultaneously obtained. In addition, because the refocused image that is of the multiple depth planes and that is corresponding to the foregoing multiple depth planes is generated based on the raw data according to depth information, there is no need to generate all refocused images. Therefore, a large amount of storage space is saved.

It should be understood that the raw data of the foregoing refocused images may be any data used to generate a refocused image, including but not limited to the following image data or a combination of the following image data.

For example, the foregoing raw data may be one or more images shot by a common camera module. The foregoing more images refer to images shot for a same scene under different shooting parameter settings, for example, different focal lengths, different apertures, different exposures, and different sensed wavelengths, or refer to images shot for a same scene in different locations.

In an embodiment, the foregoing raw data may be one or more aperture coded images shot by a camera module that is provided with an aperture mask plate, a phase mask plate, or a mask plate of another type. Further, the foregoing raw data may further be images obtained by processing the aperture coded images using various image processing algorithms.

In an embodiment, the foregoing raw data may be one or more image arrays shot by a camera module that is provided with a micro lens array or an aperture array. Further, the foregoing raw data may further be images obtained by processing the image arrays using various image processing algorithms, for example, a refocused image of a single depth plane, a fully focused image, and a virtual pinhole image.

In an embodiment, the foregoing raw data may be one or more image arrays shot by an image shooting array constituted by multiple camera modules that are provided with same or different configurations. Further, the foregoing raw data may further be images obtained by processing the image arrays using various image processing algorithms.

In an embodiment, the foregoing raw data may be a combination of depth information and images that are respectively obtained by a depth sensing device and a camera module for a same scene. The depth sensing device includes all devices that implement depth sensing using a principle such as a time of flight of light, a phase difference of light, or structured lighting.

In 120, the image processing apparatus may perform refocusing processing based on the raw data of the multiple refocused images using a refocusing algorithm to generate the multiple refocused images, and combine the multiple refocused images to generate the refocused image of the multiple depth planes.

According to this embodiment of the present application, the refocusing algorithm may be a convolution algorithm, a deconvolution algorithm, a fusion algorithm, a splicing algorithm, a light ray trace algorithm, a filtering algorithm, another refocusing algorithm of a single depth plane, or a combination of these algorithms.

In 120, the focused parts of the multiple refocused images are combined using an image fusion (Image Fusion) method.

For example, the image fusion method is an image analysis method. The image processing apparatus may combine two or more images into one image using the image fusion method. Because information about multiple images of a same scene is redundant and complementary, a synthetic image obtained using the image fusion method may represent the images more comprehensively and precisely. The image fusion method includes a grayscale-based algorithm (such as a direct average method, a weighted average method, a median filtering method, or a multi-resolution spline technology), an image fusion algorithm based on a region of interest, a fusion algorithm based on color space transform, and a fusion algorithm based on a transform domain.

In 120, when combining the focused parts of the multiple refocused images using the image fusion method, the image processing apparatus may determine a point spread function of pixels of the multiple refocused images, generate a fusion weight template according to the point spread function of the pixels, and perform image fusion on the multiple refocused images according to the fusion weight template, where the fusion weight template includes fusion weights of the pixels, and a fusion weight of a pixel of a high focusing degree is greater than a fusion weight of a pixel of a low focusing degree. That is, a focusing degree of a pixel is proportional to a fusion weight. In this way, the focused parts corresponding to the multiple depth planes are clearly presented.

For example, a focusing degree is also referred to as a degree of clearness, and a level of the focusing degree may be measured using a point spread function. In addition, the focusing degree may be evaluated using a focusing evaluation function.

According to this embodiment of the present application, each refocused image in the multiple refocused images includes focused parts and non-focused parts. In 120, when the multiple refocused images are combined, the focused parts and the non-focused parts may be selected from each refocused image in the multiple refocused images, and the focused parts and the non-focused parts are spliced. For example, the focused parts and the non-focused parts may be selected from each refocused image in the multiple refocused images.

In an embodiment, an image may be randomly selected, and the focused parts of the multiple refocused images corresponding to the multiple depth planes are fused with the image such that a transition between the focused parts and the non-focused parts is more natural.

In 120, focused parts and non-focused parts that are of each refocused image in the multiple refocused images are generated according to the raw data of the multiple refocused images, and the focused parts and the non-focused parts are spliced.

That is, the focused parts and the non-focused parts are directly generated based on the raw data. In this case, a step of capturing the focused parts and the non-focused parts is saved, and an image processing process is simplified.

According to this embodiment of the present application, in 120, the image processing apparatus may further generate, according to raw data of refocused images of all depth planes, the refocused images corresponding to all the depth planes, select the refocused images of the multiple depth planes from the refocused images of all the depth planes according to the depth information of the multiple depth planes, and generate the refocused image of the multiple depth planes according to the refocused images of the multiple depth planes, where all the depth planes are respectively corresponding to the refocused images of all the depth planes, and the refocused image of the multiple depth planes includes the focused parts of the multiple refocused images.

That is, before the depth information is determined and the refocused image of the multiple depth planes is generated, all the refocused images are pre-generated. In this way, the corresponding refocused images may be selected from the pre-generated refocused images after the depth information is determined, thereby shortening a time of generating the refocused image of the multiple depth planes, and enhancing user experience.

According to this embodiment of the present application, in 120, the image processing apparatus may determine a point spread function of pixels of all the refocused images, generate a fusion weight template according to the point spread function of the pixels of all the refocused images, where the fusion weight template includes fusion weights of the pixels of all the refocused images, fusion weights of pixels of the multiple refocused images are greater than fusion weights of pixels of other refocused images except the multiple refocused images in all the refocused images, and a fusion weight of a pixel of a high focusing degree in the multiple refocused images is greater than a fusion weight of a pixel of a low focusing degree in the multiple refocused images, and perform image fusion on all the refocused images according to the fusion weight template.

That is, the fusion weights that are of the multiple refocused images and that are determined according to the depth information are greater than the weights of the other refocused images, and for the multiple refocused images, a focusing degree of a pixel is proportional to a fusion weight. In this way, the focused parts corresponding to the multiple depth planes are clearly presented.

According to this embodiment of the present application, in 120, the image processing apparatus may select focused parts and non-focused parts from each refocused image in the multiple refocused images, and splice the focused parts and the non-focused parts.

In one embodiment, the method in FIG. 1 further includes selecting focused parts and non-focused parts from each refocused image in all the refocused images, storing the focused parts and the non-focused parts in query tables using a depth of a depth plane or pixel coordinates as an index, and querying the focused parts and non-focused parts that are of the refocused images of the multiple depth planes from the query tables using the depth of the depth plane or the pixel coordinates as the index, where the generating the refocused image of the multiple depth planes according to the refocused images of the multiple depth planes includes splicing the focused parts and the non-focused parts that are of the refocused images of the multiple depth planes.

For example, the depth of the depth plane is a distance between each depth plane and a reference plane (for example, a camera), and each depth plane may be corresponding to one depth distance. A part that is on an image and that is corresponding to each depth plane may include multiple pixels. Coordinates of each pixel may be corresponding to one depth plane. Each depth plane may be corresponding to coordinates of multiple pixels. A correspondence between the depth of the depth plane or the pixel coordinates and the focused parts, and/or a correspondence between the depth of the depth plane or the pixel coordinates and the non-focused parts may be established before the focused parts and the non-focused parts are spliced, and the foregoing correspondences are stored in the query tables. Timing for establishing the correspondences is not limited in this embodiment of the present application, for example, the correspondences may be established in a shooting process or after a shooting process, or may be established at any time before the focused parts and the non-focused parts are spliced. For example, a correspondence between the focused parts of all the depth planes and the depth of the depth plane or the pixel coordinates, and a correspondence between the non-focused parts of all the depth planes and the depth of the depth plane or the pixel coordinates may be pre-established. In this way, when the user inputs are received on the user interface, the depth of the depth plane or the pixel coordinates may be first determined according to the user inputs, then the focused parts and the non-focused parts may be acquired from the query tables according to the depth of the depth plane or the pixel coordinates, and the focused parts and the non-focused parts are spliced into the refocused image of the multiple depth planes, thereby enhancing user experience. In addition, to save storage space, a correspondence between a focused part and a non-focused part that are of raw data corresponding to a depth plane selected by the user and the depth of the depth plane or the pixel coordinates may be stored alone.

According to this embodiment of the present application, when the focused parts and the non-focused parts are spliced, pre-processing, image registration, and image fusion may be performed on images of the focused parts and images of the non-focused parts.

In one embodiment, the method in FIG. 1 further includes displaying a refocused image in the multiple refocused images, acquiring multiple user inputs in multiple regions of the displayed refocused image, and outputting the generated refocused image of the multiple depth planes on a display device, where the multiple user inputs are corresponding to the multiple depth planes, and when the depth information is determined, the depth information of the multiple depth planes may be determined according to the multiple user inputs.

For example, before the refocused image of the multiple depth planes is displayed, a refocused image of a single depth plane may be displayed on a user interface. The image processing apparatus may perform refocusing on objects in multiple different depth planes or objects in multiple discontinuous depth planes according to a user need, and output the refocused image of the multiple depth planes on the display device, or output images of refocused scenes in the different depth planes. In this embodiment of the present application, the generated refocused image of the multiple depth planes may be displayed alone, or original images and/or the refocused images that are of the different depth planes and that are generated in intermediate states before the refocused image of the multiple depth planes is generated completely may be displayed.

In an embodiment, after the refocused image of the multiple depth planes is generated, the refocused image of the multiple depth planes is immediately displayed on a user interface.

According to this embodiment of the present application, the user inputs are one of the following single-point tap inputs, multi-point tap inputs, single-point sliding inputs, or multi-point sliding inputs on a touchscreen by a user, user postures probed by a posture sensor on an input device, or user actions probed by an action tracking module on an input device.

In 110, the multiple depth planes corresponding to a predefined input may be determined according to the predefined input. The method in FIG. 1 further includes outputting, on a display device, the refocused image of the multiple depth planes corresponding to the predefined input.

The following describes the embodiments of the present application in more detail with reference to specific examples.

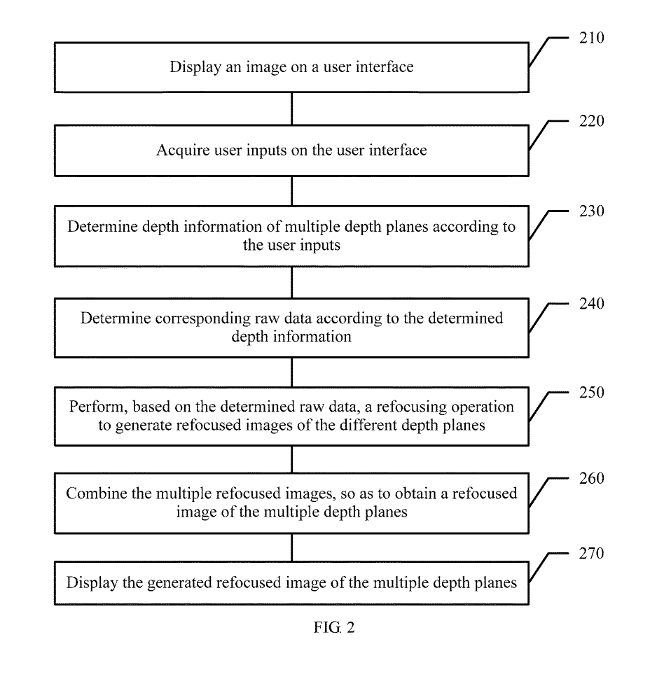

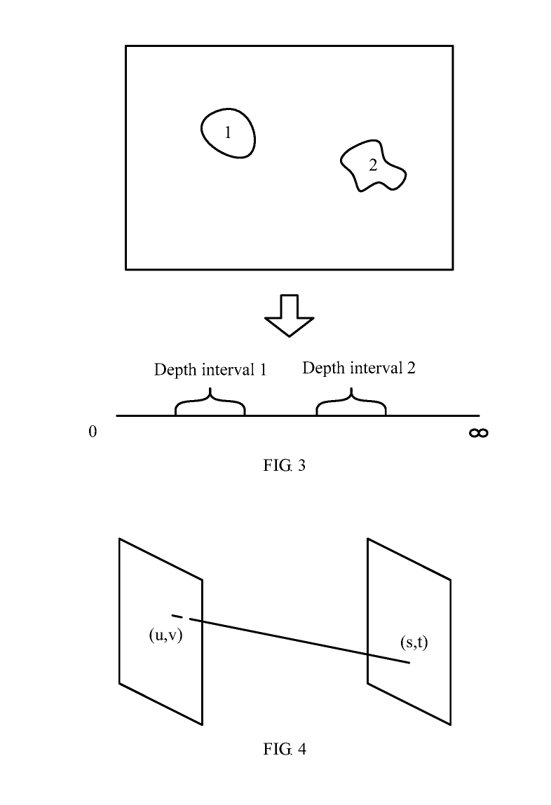

FIG. 2 is a schematic flowchart of an image processing process according to another embodiment of the present application. The embodiment in FIG. 2 is an example of the image processing method in FIG. 1. FIG. 3 shows a schematic diagram of a correspondence between a depth plane and a user input region.

210. Display an image on a user interface.

For example, an image may be displayed on a user interface of a user device (for example, a camera). The image may be a common image. The image may display scenes located in different depth planes, but can clearly display a scene only in a depth plane. The user device may store raw data of refocused images of different depth planes. A region or a location of each scene on the image is corresponding to a depth plane in which the scene is located.

220. Acquire user inputs on the user interface.

For example, when a user taps or touches multiple regions or locations of the image displayed on the user interface, the user inputs may be received in the multiple regions or locations. The foregoing user inputs may be discontinuous instructions input by the user using an input device, for example, a click on a mouse, a double-click on a mouse, pressing a button, or gently pressing a stylus on a touchscreen. Alternatively, the foregoing user inputs may be continuous instructions input by the user using an input device, for example, simply moving a mouse and recording a location of the mouse, thereby implementing a continuous click action. The input device in this embodiment of the present application may be a mouse, a touchpad, a multi-finger sensing touchscreen, a tablet or a stylus used on a screen, an eye tracking device, a joystick, a four-way button navigation control device, a pressure-sensitive direction navigation control device, a slider, a scroll wheel, a round touchpad, an infrared somatosensory device, or the like.

It should be understood that multiple depth planes may constitute a depth interval. Therefore, the multiple depth planes may be selected in a manner of selecting multiple depth intervals. Referring to FIG. 3, a region 1 and a region 2 that are on the image displayed on the user interface are corresponding to a depth interval 1 and a depth interval 2 respectively. In this way, a user may select, by selecting the regions corresponding to the two depth intervals, depth planes corresponding to the two depth intervals. It should be understood that the user may select or tap more regions or locations on the image to obtain refocused images of more depth planes.

230. Determine depth information of multiple depth planes according to the user inputs.

The depth information is used to indicate information about the multiple depth planes that need to be refocused. The depth information may include at least one of information about depth planes, information about pixel coordinates, information about pixel colors, information about a point spread function of pixels, light field information of light rays corresponding to pixels, or trace information of light rays corresponding to pixels, or any combination of them.

Raw data of refocused images may be one or more image arrays shot by a camera module that is provided with a micro lens array or an aperture array, one or more image arrays shot by an image shooting array constituted by multiple camera modules that are provided with same or different configurations, or multiple images shot by a single camera module for a same scene in different locations. Because visual difference information in an image array includes depth information of a scene, depth information of a pixel may be obtained using a method such as a block matching method, a graph cuts method, or a multi-baseline method to obtain required depth plane information. Depth information (for example, a correspondence between a depth and pixel coordinates) about an object point corresponding to each pixel may be obtained using a depth extraction method. The user inputs may indicate coordinates of selected pixels. The information about the selected depth planes may be obtained based on the coordinates of the pixels selected by a user.

Raw data of refocused images may be multiple images shot by a single common camera module. The multiple images refer to images shot for a same scene under different parameter settings, for example, different focal lengths of a lens, different apertures, different exposures, different distances between a lens and a sensor, different distances between lenses, different curvatures of lenses, or different sensed wavelengths. Because focusing degrees of an image and/or light strength information are/is different when a scene is in different depth planes, required depth plane information may be obtained using such information. For example, the user inputs indicate information about pixel coordinates. Different focusing degrees of pixels are corresponding to different depth information, and therefore the information about the depth planes selected by a user may be obtained according to the user inputs.

Raw data of refocused images may also be one or more aperture coded images shot by a camera module that is provided with an aperture mask plate, a phase mask plate, or a mask plate of another type. Because coded images are different when an object is in different depth planes, required depth plane information may be obtained using such information. For example, the user inputs indicate information about pixel coordinates, coded images generated based on pixels of different depths are different, and depth information of a pixel may be deduced from a feature of a coded image.

Raw data of refocused images may be a combination of depth information and images that are respectively obtained by a depth sensing device and a camera module for a same scene. The depth sensing device may be all devices that implement depth sensing using a principle such as a time of flight of light, a phase difference of light, or structured lighting. Therefore, required depth plane information may be obtained using a depth map provided by the depth sensing device. For example, the user inputs indicate information about selected pixel coordinates, and the information about the depth planes selected by a user may be determined provided that a correspondence (that is, a depth map) between the information about the pixel coordinates and depth information of the pixels is determined.

In the foregoing several methods, a mapping relationship or the correspondence between the information about the pixel coordinates and the depth information of the pixels is obtained in different manners.

240. Determine corresponding raw data according to the determined depth information.

The depth planes that need to be refocused may be determined according to the determined depth information, and therefore the raw data corresponding to these depth planes that need to be refocused may be determined.

250. Perform, based on the determined raw data, a refocusing operation to generate refocused images of the different depth planes (or planes).

Methods for generating the refocused images of the different depth planes include a convolution algorithm, a deconvolution algorithm, a fusion algorithm, a splicing algorithm, a light ray trace algorithm, a filtering algorithm, a refocusing algorithm of a single depth plane, or any combination of the foregoing algorithms. According to different refocusing algorithms, before the refocused images of the different depth planes are generated, a focusing degree of a pixel, a radius of a circle of confusion, a point spread function, a gradient, a strength difference, or a structure tensor, or any combination of them may be acquired. The focusing degree of the pixel, the radius of the circle of confusion, the point spread function, the gradient, the strength difference, and the structure tensor may be calculated by means of convolution, deconvolution, Fourier Transform, inverse Fourier Transform, interpolation, or derivation, or any combination of them, or may be obtained using a method such as machine learning, statistics, or theory emulation.

In this embodiment of the present application, the refocused images of the different depth planes may be obtained using a technology such as light field reconstruction, three-dimensional reconstruction, or a synthetic aperture. For details about a specific example of the refocusing operation, refer to an embodiment in FIG. 6.

To reduce an operation, only the refocused images corresponding to the multiple depth planes selected according to the user inputs are generated when the user inputs are received. This embodiment of the present application is not limited thereto, for example, refocused images of all depth planes may be pre-generated, and then, when the user inputs are received, the refocused images of the multiple depth planes selected according to the user inputs may be directly selected from these refocused images.

260. Combine the multiple refocused images to obtain a refocused image of the multiple depth planes.

In this embodiment of the present application, the multiple refocused images may be combined using an image fusion method. In the image fusion method, weight-based fusion may be used. In this embodiment of the present application, fusion weights may be calculated before the refocused images of the different depth planes are fused. To reduce calculation, only the refocused images corresponding to the selected multiple depth planes are fused. Information about the fusion weights may be stored in a same file as the refocused images, or a fusion weight template or a query table may be separately formed and separately stored in another file.

In an embodiment, the multiple refocused images may be combined using an image splicing method.

270. Display the generated refocused image of the multiple depth planes.

For example, after generating the refocused images of the different depth planes, a camera may immediately display the generated refocused image of the multiple depth planes on a user interface. In addition, when the generated refocused image of the multiple depth planes is displayed, original images and/or the refocused images that are of the different depth planes and that are generated in intermediate states before the refocused image of the multiple depth planes is generated completely may also be displayed. For example, multiple images may be displayed in a split-screen manner on a same user interface.

It should be understood that a step of generating the refocused images of the different depth planes may be performed in any step before the refocused image of the multiple depth planes is obtained by means of synthesis, for example, may be performed in a shooting process, may be performed immediately after a shooting process is completed, or may be performed when the refocused image of the multiple depth planes needs to be obtained by means of synthesis, which is not limited in this embodiment of the present application.

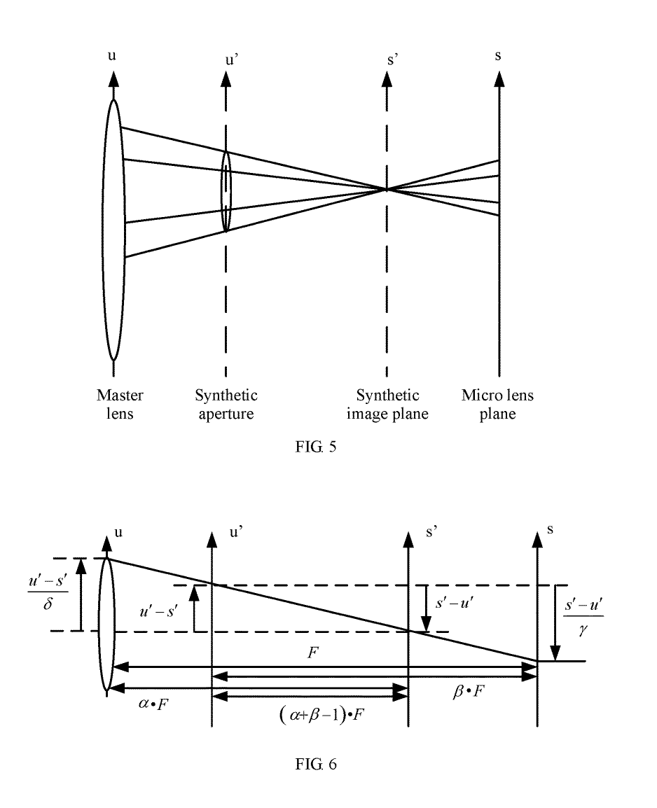

The following describes how to generate the refocused images of the different depth planes using a light field camera as an example. FIG. 4 is a schematic diagram of two planes in a double-plane representation method according to an embodiment of the present application. FIG. 5 is a schematic diagram of a principle of synthetic image photography according to an embodiment of the present application. FIG. 6 is a schematic diagram of a geometrical relationship of a model of a principle of synthetic image photography according to an embodiment of the present application.

The light field camera includes a master lens and an image sensor (which is not shown), and a micro lens array is disposed between the master lens and the image sensor. The image sensor records small images formed in each micro lens, and the multiple small images constitute an image array. The light field camera may be further provided with corresponding image processing software to reconstruct the recorded image array into a common image form that can be accepted by a user and present effects of performing focusing on the different depth planes and effects of viewing a scene from different perspectives. After a shooting process is completed, the light field camera may perform, according to a user need and using the software, refocusing on the depth planes selected by the user. A focusing depth of an image may not be fixed, and may be changed according to a user need. In addition to recording strength information of a light ray, the light field camera also records angle information of the light ray. The angle information of the light ray includes depth information of a scene in a scene. That is, the light field camera collects three-dimensional information (for example, three-dimensional light field data) about the scene. After acquiring the three-dimensional data about the scene, the light field camera may separately focus, according to a user need, the different depth planes using a refocusing algorithm. When the user selects a region (the region may be corresponding to a depth plane in the scene) in the image displayed on the user interface, the camera may process the image using the refocusing algorithm, and eventually present an effect of focusing on the selected depth plane. When the user selects multiple regions in the image displayed on the user interface, the camera may first generate, according to the raw data, the refocused images of the multiple depth planes corresponding to the multiple regions before the refocused image of the multiple depth planes is generated, and then fuse or splice the refocused images to obtain the refocused image of the multiple depth planes.

As shown in FIG. 4, the double-plane representation method may be used to represent a light field, that is, coordinates of a light ray L are coordinates of intersection points formed when the light ray is in two parallel planes u-v and s-t. For example, light field information collected by the light field camera is represented using L (u, v, s, t), and light field information of a synthetic light field of the light field camera is represented using L′ (u′, v′, s′, t′). A relationship between the light field information collected by the light field camera and the light field information of the synthetic light field is shown in FIG. 5.

A value of an irradiance image of a synthetic image plane is:

$$E ( {s}^{′} , {t}^{′} ) = \frac{1}{{D}^{2}} \int \int {L}^{′} ( {u}^{′} , {v}^{′} , {s}^{′} , {t}^{′} ) A ( {u}^{′} , {v}^{′} ) {cos}^{4} d u d v , \qquad ( 1 )$$

where

D is a distance between the synthetic image plane and a synthetic aperture, A is an aperture function, for example, a value inside an aperture is 1, and a value outside the aperture is 0, and θ is an incidence angle between the synthetic image plane and a light ray (u′, v′, s′, t′).

According to a principle of paraxial approximation, cos⁴ θ in the foregoing formula may be ignored, and after 1/D² is ignored, the following formula is obtained.

Ē(s′, t′)=∫∫L′(u′, v′, s′, t′)A(u′, v′)du dv (2)

A relationship between L and L′ is shown in FIG. 6, and the field information L (u, v, s, t) may be used to represent formula (2). According to the principle of synthetic image photography, the relationship between L and L′ may be obtained as follows:

$$\begin{matrix} γ = \frac{α + β - 1}{α} and δ = \frac{α + β - 1}{β} & ( 3 ) \\ {L}^{′} ( {u}^{′} , {v}^{′} , {s}^{′} , {t}^{′} ) = L ( {s}^{′} + \frac{{u}^{′} - {s}^{′}}{δ} , {t}^{′} + \frac{{v}^{′} - {t}^{′}}{δ} , {u}^{′} + \frac{{s}^{′} - {u}^{′}}{γ} , {v}^{′} + \frac{{t}^{′} - {v}^{′}}{γ} ) , & ( 4 )\end{matrix}$$

where

a represents a proportional coefficient of a distance between a master lens plane and the synthetic image plane, β represents a proportional coefficient of a distance between a synthetic aperture plane and a micro lens plane.

A synthetic image photography formula is obtained according to formulas (4) and (2).

$$\overline{E} ( {s}^{′} , {t}^{′} ) = \int \int L ( {s}^{′} + \frac{{u}^{′} - {s}^{′}}{δ} , {t}^{′} + \frac{{v}^{′} - {t}^{′}}{δ} , {u}^{′} + \frac{{s}^{′} - {u}^{′}}{γ} , {v}^{′} + \frac{{t}^{′} - {v}^{′}}{γ} ) A ( {u}^{′} , {v}^{′} ) d u d v \qquad ( 5 )$$

The refocused images of the different depth planes may be obtained by drawing images according to formula (5).

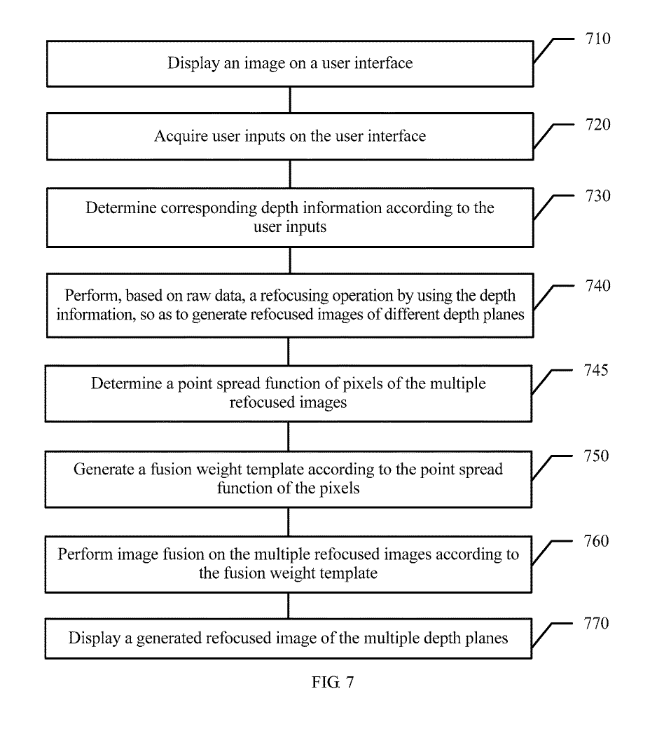

FIG. 7 is a schematic flowchart of an image processing process according to still another embodiment of the present application. The embodiment in FIG. 7 is an example of the image processing method in FIG. 1, and detailed descriptions are appropriately omitted herein. Steps 710 to 740 in FIG. 7 are respectively similar to steps 210 to 240 in FIG. 2, and details are not described herein.

710. Display an image on a user interface.

720. Acquire user inputs on the user interface.

730. Determine corresponding depth information according to the user inputs.

740. Perform, based on raw data, a refocusing operation using the depth information to generate refocused images of different depth planes.

745. Determine a point spread function of pixels of the multiple refocused images.

750. Generate a fusion weight template according to the point spread function of the pixels.

760. Perform image fusion on the multiple refocused images according to the fusion weight template.

770. Display a generated refocused image of the multiple depth planes.

It should be understood that the step of determining a point spread function of pixels in step 745 may be replaced by a step of determining focusing degrees of the pixels, a radius of a circle of confusion, a gradient, a strength difference, a structure tensor, light field information of light rays corresponding to the pixels, or trace information of light rays corresponding to the pixels, or any combination of them. That is, the point spread function may be replaced by these parameters.

It should be understood that the step of determining a point spread function may be performed in any step before the fusion weight template is generated.

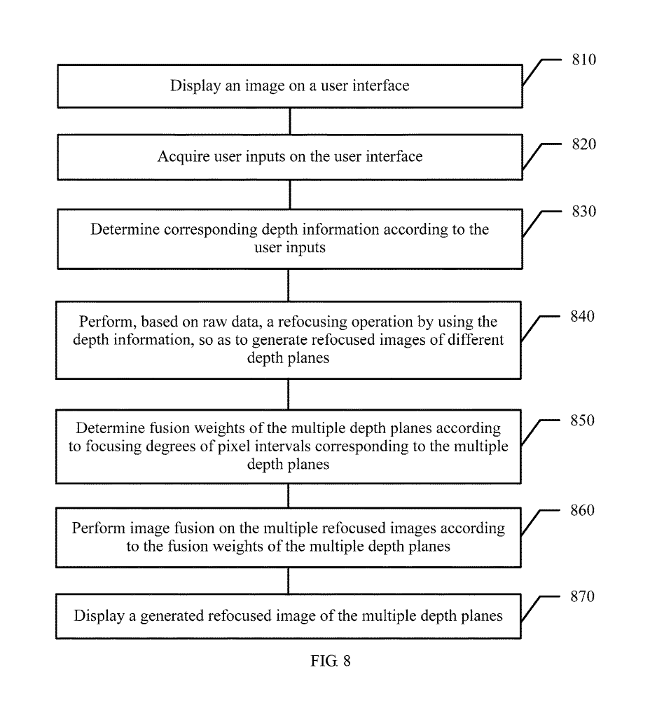

FIG. 8 is a schematic flowchart of an image processing process according to another embodiment of the present application. The embodiment in FIG. 8 is an example of the image processing method in FIG. 1, and detailed descriptions are appropriately omitted herein. Steps 810 to 840 in FIG. 8 are respectively similar to steps 210 to 240 in FIG. 2, and details are not described herein.

810. Display an image on a user interface.

820. Acquire user inputs on the user interface.

830. Determine corresponding depth information according to the user inputs.

840. Perform, based on raw data, a refocusing operation using the depth information to generate refocused images of different depth planes.

850. Determine fusion weights of pixels according to focusing degrees of the pixels of the refocused images, where a fusion weight of a pixel of a high focusing degree is greater than a fusion weight of a pixel of a low focusing degree in a same refocused image.

860. Perform image fusion on the multiple refocused images according to the fusion weights of the multiple depth planes.

870. Display a generated refocused image of the multiple depth planes.

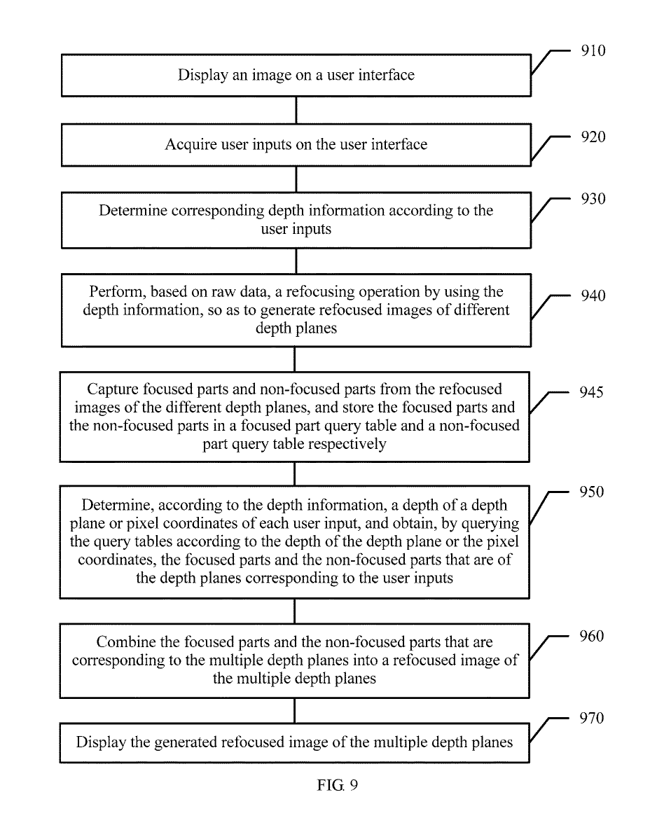

FIG. 9 is a schematic flowchart of an image processing process according to still another embodiment of the present application. The embodiment in FIG. 9 is an example of the image processing method in FIG. 1, and detailed descriptions are appropriately omitted herein.

910. Display an image on a user interface. Step 910 is similar to step 210 in FIG. 2, and details are not described herein.

920. Acquire user inputs on the user interface. Step 920 is similar to step 220 in FIG. 2, and details are not described herein.

930. Determine corresponding depth information according to the user inputs.

For example, the depth information may include a depth of a depth plane or pixel coordinates, where the depth plane and the pixel coordinates are corresponding to each user input region. The pixel coordinates may be coordinates of any pixel in the region, for example, may be coordinates of a central point of the region.

940. Perform, based on raw data, a refocusing operation using the depth information to generate refocused images of different depth planes.

945. Capture focused parts and non-focused parts from the refocused images of the different depth planes, and store the focused parts and the non-focused parts in a focused part query table and a non-focused part query table respectively.

In an embodiment, refocused images of all depth planes may be pre-generated (for example, before the user inputs are received) according to raw data, and then the focused parts and the non-focused parts are captured from the refocused images of all the depth planes and are respectively stored in the focused part query table and the non-focused part query table, or focused parts and non-focused parts that are of all depth planes are pre-generated according to raw data, and the focused parts and the non-focused parts are respectively stored in the focused part query table and the non-focused part query table. In this case, steps 940 and 945 may be omitted.

In the foregoing focused part query table, a correspondence between a depth of a depth plane or pixel coordinates and the focused parts is stored. In the foregoing non-focused part query table, a correspondence between a depth of a depth plane or pixel coordinates and the non-focused parts is stored.

950. Determine, according to the depth information, a depth of a depth plane or pixel coordinates of each user input, and obtain, by querying the query tables according to the depth of the depth plane or the pixel coordinates, the focused parts and the non-focused parts that are of the depth planes corresponding to the user inputs.

960. Combine the focused parts and the non-focused parts that are corresponding to the multiple depth planes into a refocused image of the multiple depth planes.

In this embodiment of the present application, the focused parts and the non-focused parts that are corresponding to the multiple depth planes may be combined into the refocused image of the multiple depth planes using an image splicing method. For example, focused regions and non-focused regions may be captured from the images, and the refocused image of the multiple depth planes is generated by splicing the foregoing regions. Each focused region and each non-focused region separately include at least one pixel. An image splicing process mainly includes three steps pre-processing, registration, and fusion. The pre-processing includes image denoising, image correction, and image projection. The image projection may be performed using a plane projection method, a spherical projection method, a cube projection method, or a cylinder projection method. The image denoising may be performed using a neighborhood average method, a spatial domain low-pass filtering method, or a spatial domain non-linear filtering method. The image correction may be a correction for a grayscale value deviation, or a correction for geometric deformation. For example, in a correction method for the grayscale value deviation, a normalized image grayscale value is:

$$\{ \begin{matrix}{f}^{′} = \frac{f - {μ}_{f}}{{σ}_{f}} \\ {g}^{′} = \frac{g - {μ}_{g}}{{σ}_{g}}\end{matrix} ,$$

where

f represents a grayscale of a reference image, μ_{f} represents an average grayscale of the reference image, σ_{f} represents a standard deviation of the reference image, g represents a grayscale of a to-be-spliced image, μ_{g} represents an average grayscale of the to-be-spliced image, and σ_{g} represents a standard deviation of the to-be-spliced image.

A method for the image registration may be a block matching algorithm, an image registration method based on fast Fourier Transform, a phase correlation image registration method based on Fourier Transform, an algorithm based on a contour feature, a corner detection algorithm, a scale-invariant feature transform (SIFT) algorithm, a speeded up robust features (SURF) algorithm, an optical flow based method, or an SIFT flow based method. A corresponding location of the to-be-spliced image may be determined using a registration algorithm, re-sampling is performed after a transform relationship among images is determined, and then the images may be spliced. An image transform model may be image translation, rotation, scaling, reflection, or shearing, or any combination of them.

970. Display the generated refocused image of the multiple depth planes. Step 970 is similar to step 270 in FIG. 2, and details are not described herein.

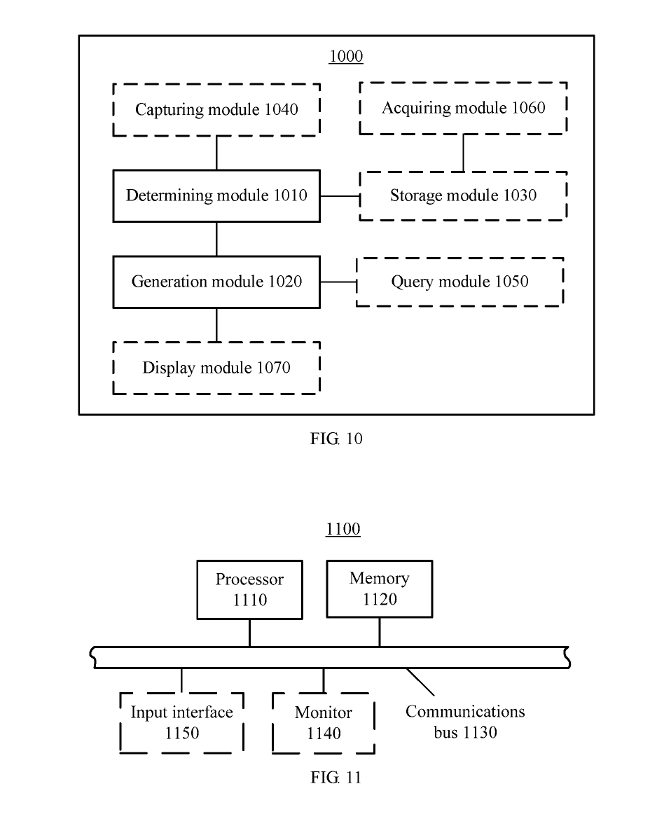

The image processing method and process according to the embodiments of the present application are described in the foregoing. An image processing apparatus according to the embodiments of the present application is described in the following with reference to FIG. 10 and FIG. 11 separately.

FIG. 10 is a schematic structural diagram of an image processing apparatus 1000 according to an embodiment of the present application. The image processing apparatus 1000 includes a determining module 1010 and a generation module 1020.

The determining module 1010 is configured to determine depth information of multiple depth planes, where the depth information of the multiple depth planes is used to indicate the multiple depth planes, the multiple depth planes are respectively corresponding to multiple refocused images of the multiple depth planes, and the multiple refocused images are generated based on raw data of the multiple refocused images. The generation module 1020 is configured to generate a refocused image of the multiple depth planes according to the depth information, where the refocused image of the multiple depth planes includes focused parts of the multiple refocused images.

According to this embodiment of the present application, the multiple depth planes are respectively corresponding to the raw data of the multiple refocused images, and the generation module 1020 determines the raw data of the multiple refocused images according to the depth information of the multiple depth planes, and generates the refocused image of the multiple depth planes according to the raw data of the multiple refocused images, where the refocused image of the multiple depth planes includes the focused parts of the multiple refocused images.

The generation module 1020 performs refocusing processing based on the raw data of the multiple refocused images using a refocusing algorithm to generate the multiple refocused images, and combines the multiple refocused images to generate the refocused image of the multiple depth planes.

According to this embodiment of the present application, the generation module 1020 combines the focused parts of the multiple refocused images using an image fusion method.

According to this embodiment of the present application, the generation module 1020 determines a point spread function of pixels of the multiple refocused images, generates a fusion weight template according to the point spread function of the pixels, and performs image fusion on the multiple refocused images according to the fusion weight template, where the fusion weight template includes fusion weights of the pixels, and a fusion weight of a pixel of a high focusing degree is greater than a fusion weight of a pixel of a low focusing degree.

According to this embodiment of the present application, the generation module 1020 captures focused parts and non-focused parts from each refocused image in the multiple refocused images, and splices the focused parts and the non-focused parts.

According to this embodiment of the present application, the generation module 1020 determines the raw data of the multiple refocused images according to the depth information of the multiple depth planes, generates, according to the raw data of the multiple refocused images, focused parts and non-focused parts that are of each refocused image in the multiple refocused images, and splices the focused parts and the non-focused parts.

According to this embodiment of the present application, the generation module 1020 further generates, according to raw data of refocused images of all depth planes, the refocused images corresponding to all the depth planes, where all the depth planes are respectively corresponding to the refocused images of all the depth planes. The generation module 1020 selects the refocused images of the multiple depth planes from the refocused images of all the depth planes according to the depth information of the multiple depth planes, and generates the refocused image of the multiple depth planes according to the refocused images of the multiple depth planes, where the refocused image of the multiple depth planes includes the focused parts of the multiple refocused images.

According to this embodiment of the present application, the generation module 1020 determines a point spread function of pixels of all the refocused images, generates a fusion weight template according to the point spread function of the pixels of all the refocused images, and performs image fusion on all the refocused images according to the fusion weight template, where the fusion weight template includes fusion weights of the pixels of all the refocused images, fusion weights of pixels of the multiple refocused images are greater than fusion weights of pixels of other refocused images except the multiple refocused images in all the refocused images, and a fusion weight of a pixel of a high focusing degree in the multiple refocused images is greater than a fusion weight of a pixel of a low focusing degree in the multiple refocused images.

According to this embodiment of the present application, the generation module 1020 selects focused parts and non-focused parts from each refocused image in the multiple refocused images, and splices the focused parts and the non-focused parts.

In an embodiment, the image processing apparatus 1000 further includes a storage module 1030, a selection module 1040, and a query module 1050. The selection module 1040 is configured to select focused parts and non-focused parts from each refocused image in all the refocused images. The storage module 1030 is configured to respectively store the focused parts and the non-focused parts into query tables using a depth of a depth plane or pixel coordinates as an index. The query module 1050 queries the focused parts and non-focused parts that are of the refocused images of the multiple depth planes from the query tables using the depth of the depth plane or the pixel coordinates as the index. The generation module 1020 splices the focused parts and the non-focused parts that are of the refocused images of the multiple depth planes.

According to this embodiment of the present application, the generation module 1020 performs pre-processing, image registration, and image fusion on images of the focused parts and images of the non-focused parts when performing the splicing.

In an embodiment, the image processing apparatus 1000 further includes a display module 1070 configured to display a refocused image in the multiple refocused images, and an acquiring module 1060 configured to acquire multiple user inputs in multiple regions of the displayed refocused image, where the multiple user inputs are corresponding to the multiple depth planes. The display module 1070 outputs the refocused image of the multiple depth planes on a display device. The determining module 1010 determines the depth information of the multiple depth planes according to the multiple user inputs.

According to this embodiment of the present application, the user inputs are one of the following single-point tap inputs, multi-point tap inputs, single-point sliding inputs, or multi-point sliding inputs on a touchscreen by a user, user postures probed by a posture sensor on an input device, or user actions probed by an action tracking module on an input device.

In an embodiment of the present application, the determining module 1010 determines, according to a predefined input, the multiple depth planes corresponding to the predefined input. The image processing apparatus 1000 further includes a display module 1030 configured to output, on a display device, the refocused image of the multiple depth planes corresponding to the predefined input.

For an operation and a function of each unit of the image processing apparatus 1000, reference may be made to the method in FIG. 1. To avoid repetition, details are not described herein.

FIG. 11 is a schematic structural diagram of an image processing apparatus 1100 according to another embodiment of the present application. The image processing apparatus 1100 includes a processor 1110, a memory 1120, and a communications bus 1130.

By invoking code stored in the memory 1120 using the communications bus 1130, the processor 1110 is configured to determine depth information of multiple depth planes, where the depth information of the multiple depth planes is used to indicate the multiple depth planes, the multiple depth planes are respectively corresponding to multiple refocused images of the multiple depth planes, and the multiple refocused images are generated based on raw data of the multiple refocused images, and generate a refocused image of the multiple depth planes according to the depth information, where the refocused image of the multiple depth planes includes focused parts of the multiple refocused images.

According to this embodiment of the present application, the multiple depth planes are respectively corresponding to the raw data of the multiple refocused images, and the processor 1110 determines the raw data of the multiple refocused images according to the depth information of the multiple depth planes, and generates the refocused image of the multiple depth planes according to the raw data of the multiple refocused images, where the refocused image of the multiple depth planes includes the focused parts of the multiple refocused images.

According to this embodiment of the present application, the processor 1110 performs refocusing processing based on the raw data of the multiple refocused images using a refocusing algorithm to generate the multiple refocused images, and combines the multiple refocused images to generate the refocused image of the multiple depth planes.

According to this embodiment of the present application, the processor 1110 combines the focused parts of the multiple refocused images using an image fusion method.

According to this embodiment of the present application, the processor 1110 determines a point spread function of pixels of the multiple refocused images, generates a fusion weight template according to the point spread function of the pixels, and performs image fusion on the multiple refocused images according to the fusion weight template, where the fusion weight template includes fusion weights of the pixels, and a fusion weight of a pixel of a high focusing degree is greater than a fusion weight of a pixel of a low focusing degree.

According to this embodiment of the present application, the processor 1110 selects focused parts and non-focused parts from each refocused image in the multiple refocused images, and splices the focused parts and the non-focused parts.

According to this embodiment of the present application, the processor 1110 determines the raw data of the multiple refocused images according to the depth information of the multiple depth planes, generates, according to the raw data of the multiple refocused images, focused parts and non-focused parts that are of each refocused image in the multiple refocused images, and splices the focused parts and the non-focused parts.

According to this embodiment of the present application, the processor 1110 further generates, according to raw data of refocused images of all depth planes, the refocused images corresponding to all the depth planes, where all the depth planes are respectively corresponding to the refocused images of all the depth planes. The processor 1110 selects the refocused images of the multiple depth planes from the refocused images of all the depth planes according to the depth information of the multiple depth planes, and generates the refocused image of the multiple depth planes according to the refocused images of the multiple depth planes, where the refocused image of the multiple depth planes includes the focused parts of the multiple refocused images.

According to this embodiment of the present application, the processor 1110 determines a point spread function of pixels of all the refocused images, generates a fusion weight template according to the point spread function of the pixels of all the refocused images, and performs image fusion on all the refocused images according to the fusion weight template, where the fusion weight template includes fusion weights of the pixels of all the refocused images, fusion weights of pixels of the multiple refocused images are greater than fusion weights of pixels of other refocused images except the multiple refocused images in all the refocused images, and a fusion weight of a pixel of a high focusing degree in the multiple refocused images is greater than a fusion weight of a pixel of a low focusing degree in the multiple refocused images.

According to this embodiment of the present application, the processor 1110 selects focused parts and non-focused parts from each refocused image in the multiple refocused images, and splices the focused parts and the non-focused parts.

According to this embodiment of the present application, the processor 1110 performs pre-processing, image registration, and image fusion on images of the focused parts and images of the non-focused parts when performing the splicing.

In an embodiment, the image processing apparatus 1100 further includes a monitor 1140 configured to display a refocused image in the multiple refocused images, and an input interface 1150 configured to acquire multiple user inputs in multiple regions of the displayed refocused image, where the multiple user inputs are corresponding to the multiple depth planes. The monitor 1140 outputs the generated refocused image of the multiple depth planes. The processor 1110 determines the depth information of the multiple depth planes according to the multiple user inputs.

According to this embodiment of the present application, the user inputs are one of the following single-point tap inputs, multi-point tap inputs, single-point sliding inputs, or multi-point sliding inputs on a touchscreen of the monitor 1140 by a user, user postures probed by a posture sensor on an input device, or user actions probed by an action tracking module on an input device.

In an embodiment, the processor 1110 determines, according to a predefined input, the multiple depth planes corresponding to the predefined input. The image processing apparatus further includes a monitor 1140 configured to output, on a display device, the refocused image of the multiple depth planes corresponding to the predefined input.

For an operation and a function of each unit of the image processing apparatus 1100, reference may be made to the method in FIG. 1. To avoid repetition, details are not described herein.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present application.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein.

In the several embodiments provided in this application, it should be understood that the disclosed system, apparatus, and method may be implemented in other manners. For example, the described apparatus embodiment is merely exemplary. For example, the unit division is merely logical function division and may be other division in actual implementation. For example, multiple units or components may be combined or integrated into another system, or some features may be ignored or not performed. In addition, the displayed or discussed mutual couplings or direct couplings or communication connections may be implemented using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on multiple network units. Some or all of the units may be selected according to actual needs to achieve the objectives of the solutions of the embodiments.

In addition, functional units in the embodiments of the present application may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of the present application essentially, or the part contributing to the prior art, or some of the technical solutions may be implemented in a form of a software product. The software product is stored in a storage medium, and includes several instructions for instructing a computer device (which may be a personal computer, a server, a network device, or the like) to perform all or some of the steps of the methods described in the embodiments of the present application. The foregoing storage medium includes any medium that can store program code, such as a universal serial bus (USB) flash drive, a removable hard disk, a read-only memory (ROM), a random access memory (RAM), a magnetic disk, or an optical disc.

The foregoing descriptions are merely specific implementation manners of the present application, but are not intended to limit the protection scope of the present application. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. An image processing method, comprising
determining depth information of multiple depth planes, wherein the depth information of the multiple depth planes is used to indicate the multiple depth planes, wherein the multiple depth planes are respectively corresponding to multiple refocused images of the multiple depth planes, and wherein the multiple refocused images are generated based on raw data of the multiple refocused images; and
generating a refocused image of the multiple depth planes according to the depth information, wherein the refocused image of the multiple depth planes comprises focused parts of the multiple refocused images.

2. The image processing method according to claim 1, wherein the multiple depth planes are respectively corresponding to the raw data of the multiple refocused images, and wherein generating the refocused image of the multiple depth planes according to the depth information comprises:
determining the raw data of the multiple refocused images according to the depth information of the multiple depth planes; and
generating the refocused image of the multiple depth planes according to the raw data of the multiple refocused images, wherein the refocused image of the multiple depth planes comprises the focused parts of the multiple refocused images.

3. The image processing method according to claim 2, wherein generating the refocused image of the multiple depth planes according to the raw data of the multiple refocused images comprises:
performing refocusing processing based on the raw data of the multiple refocused images using a refocusing algorithm to generate the multiple refocused images, and
combining the multiple refocused images to generate the refocused image of the multiple depth planes.

4. The image processing method according to claim 3, wherein combining the multiple refocused images comprises combining the focused parts of the multiple refocused images using an image fusion method.

5. The image processing method according to claim 4, wherein combining the focused parts of the multiple refocused images using the image fusion method comprises:
determining a point spread function of pixels of the multiple refocused images;
generating a fusion weight template according to the point spread function of the pixels, wherein the fusion weight template comprises fusion weights of the pixels, and wherein a fusion weight of a pixel of a high focusing degree is greater than a fusion weight of a pixel of a low focusing degree; and
performing image fusion on the multiple refocused images according to the fusion weight template.

6. The image processing method according to claim 3, wherein each refocused image in the multiple refocused images comprises focused parts and non-focused parts, and wherein combining the multiple refocused images comprises:
selecting the focused parts and the non-focused parts from each refocused image in the multiple refocused images; and
splicing the focused parts and the non-focused parts.

7. The image processing method according to claim 2, wherein generating the refocused image of the multiple depth planes according to the raw data of the multiple refocused images comprises:
generating, according to the raw data of the multiple refocused images, focused parts and non-focused parts that are of each refocused image in the multiple refocused images; and
splicing the focused parts and the non-focused parts.

8. The image processing method according to claim 1, further comprising:
generating, according to raw data of refocused images of all depth planes, the refocused images corresponding to all the depth planes, wherein all the depth planes are respectively corresponding to the refocused images of all the depth planes,
wherein generating a refocused image of the multiple depth planes according to the depth information comprises:
selecting the refocused images of the multiple depth planes from the refocused images of all the depth planes according to the depth information of the multiple depth planes; and
generating the refocused image of the multiple depth planes according to the refocused images of the multiple depth planes, wherein the refocused image of the multiple depth planes comprises the focused parts of the multiple refocused images.

9. The image processing method according to claim 8, wherein generating the refocused image of the multiple depth planes according to the refocused images of the multiple depth planes comprises
determining a point spread function of pixels of all the refocused images;
generating a fusion weight template according to the point spread function of the pixels of all the refocused images, wherein the fusion weight template comprises fusion weights of the pixels of all the refocused images, wherein fusion weights of pixels of the multiple refocused images are greater than fusion weights of pixels of other refocused images except the multiple refocused images in all the refocused images, and wherein a fusion weight of a pixel of a high focusing degree in the multiple refocused images is greater than a fusion weight of a pixel of a low focusing degree in the multiple refocused images; and
performing image fusion on all the refocused images according to the fusion weight template.

10. The image processing method according to claim 8, wherein generating the refocused image of the multiple depth planes according to the refocused images of the multiple depth planes comprises:
selecting focused parts and non-focused parts from each refocused image in the multiple refocused images; and
splicing the focused parts and the non-focused parts.

11. The image processing method according to claim 8, further comprising querying the focused parts and non-focused parts that are of the refocused images of the multiple depth planes from query tables using a depth of a depth plane or pixel coordinates as an index, wherein the focused parts and the non-focused parts are stored in the query tables using the depth of the depth plane or the pixel coordinates as the index, wherein generating the refocused image of the multiple depth planes according to the refocused images of the multiple depth planes comprises splicing the focused parts and the non-focused parts that are of the refocused images of the multiple depth planes.

12. The image processing method according to claim 6, wherein splicing the focused parts and the non-focused parts comprises performing pre-processing, image registration, and image fusion on images of the focused parts and images of the non-focused parts.

13. The image processing method according to claim 1, further comprising
displaying a refocused image in the multiple refocused images;
acquiring multiple user inputs in multiple regions of the displayed refocused image, wherein the multiple user inputs are corresponding to the multiple depth planes; and
outputting the generated refocused image of the multiple depth planes on a display device, wherein determining depth information of multiple depth planes comprises determining the depth information of the multiple depth planes according to the multiple user inputs.

14. The image processing method according to claim 13, wherein the user inputs are at least one of single-point tap inputs, multi-point tap inputs, single-point sliding inputs, multi-point sliding inputs on a touchscreen by a user, user postures probed by a posture sensor on an input device, or user actions probed by an action tracking module on an input device.

15. The image processing method according to claim 1, wherein determining the depth information of multiple depth planes comprises determining, according to a predefined input, the multiple depth planes corresponding to the predefined input, and the method further comprises outputting, on a display device, the refocused image of the multiple depth planes corresponding to the predefined input.

16. An image processing apparatus, comprising:
a processor configured to:
determine depth information of multiple depth planes, wherein the depth information of the multiple depth planes is used to indicate the multiple depth planes, and the multiple depth planes are respectively corresponding to multiple refocused images of the multiple depth planes; and
generate a refocused image of the multiple depth planes according to the depth information, wherein the refocused image of the multiple depth planes comprises focused parts of the multiple refocused images.

17. The image processing apparatus according to claim 16, wherein the multiple depth planes are respectively corresponding to raw data of the multiple refocused images, and wherein the processor is further configured to:
determine the raw data of the multiple refocused images according to the depth information of the multiple depth planes; and
generate the refocused image of the multiple depth planes according to the raw data of the multiple refocused images, wherein the refocused image of the multiple depth planes comprises the focused parts of the multiple refocused images.

18. The image processing apparatus according to claim 17, wherein the processor is further configured to:
perform refocusing processing based on the raw data of the multiple refocused images using a refocusing algorithm to generate the multiple refocused images; and
combine the multiple refocused images to generate the refocused image of the multiple depth planes.

19. The image processing apparatus according to claim 18, wherein the processor is further configured to combine the focused parts of the multiple refocused images using an image fusion method.

20. The image processing apparatus according to claim 19, wherein the processor is further configured to:
determine a point spread function of pixels of the multiple refocused images, generates a fusion weight template according to the point spread function of the pixels; and
perform image fusion on the multiple refocused images according to the fusion weight template, wherein the fusion weight template comprises fusion weights of the pixels, and wherein a fusion weight of a pixel of a high focusing degree is greater than a fusion weight of a pixel of a low focusing degree.
